(19) United States
(12) Patent Application Publication
(10) Pub. No.: US 2007/0202870 A1
(43) Pub. Date: Aug. 30, 2007

(54) Providing call information of a child in wireless networks

(75) Inventors: Sean X. Bian, Naperville, IL (US); Huixian Song, Naperville, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/361,470

(22) Filed: Feb. 24, 2006

(51) Int. Cl. H04Q 7/20

(52) U.S. Cl. 455/428

(57) ABSTRACT

Wireless networks and associated methods are disclosed that provide a child call log service. A communication network of the invention comprises a network node and a child call log system. The network node serves calls for a mobile device of a child, and records call information for the calls of the child connected over the wireless network. The child call log system stores the call information for the calls in a call log for the child. A parent of the child is able to access the call information for the child by transmitting a request for the call information to the wireless network through a mobile device. The child call log system receives the request and accesses the call log for the child to identify the call information. The child call log system then provides the call information for the child to the mobile device of the parent.

### BACKGROUND OF THE INVENTION

1. Field of the Invention

The invention is related to the field of communication networks and, in particular, to providing a child call log service in wireless networks that allows a parent to access call information of a child using a mobile device.

2. Statement of the Problem

With the popularity of cellular phones, many families are signing up for service and have multiple cell phones. A family may sign up for a sharing plan where two or more lines share a common monthly usage. A family may also sign up for individual plans for the family members. With family usage increasing, many children have their own cell phones. One concern for parents giving their children cell phones is misusage of the phone. For instance, a child may place calls to people that are not authorized by the parents, or may place long-duration calls to their friends. A child may also access the internet on internet-capable phones which may cause the parents to incur higher rates.

Presently, parents may track the phone usage of their children by viewing the monthly statements provided by the service provider. These monthly statements are typically included with the monthly bills. Some service providers also provide the monthly statements online, which allows the parents to view the last-month's statement and previous-monthly statements through a web site of the service provider.

Some problems presently exist for allowing parents to view the cell phone usage of their children. For one, the parents have to wait for the service provider to send a monthly statement or post the monthly statement online before it can be viewed. This does not allow a parent to view recent usage, such as in the last day, the last week, etc. Another problem is that to view the statements provided online, the parents need to have internet access. Not all parents have internet access and do not have the ability to view cell phone usage of their children online.

Some service providers of VoIP service provide a web site that allows a parent to view current call information of a child using a VoIP phone. Once again, it may be a problem to view a web site as a parent may not have internet access. The VoIP service providers do not provide a mechanism that allows a parent to view the call information for the child over his/her VoIP phone.

### SUMMARY OF THE SOLUTIONS

The invention solves the above and other problems by providing a child call log service in wireless networks. According to the child call log service, the wireless network tracks the usage of a child placing or receiving calls in the wireless network, and stores call information for the child in a call log. A parent may then access the call information in the call log through the wireless network and his/her mobile device to determine with whom the child has been conversing, the duration of the calls of the child, the type of the calls, etc. The wireless network updates the call log of the child based on the usage of the child so that the parent may advantageously access recent call information for the child, such as within the last hour, the last day, the last week, etc. The parent does not need to wait to receive a monthly statement in order to view the child's call information. The parent may advantageously access the child's call information from the wireless network through their mobile device (e.g., a cell phone). The parent does not need to have internet access to acquire the child's call information.

In one embodiment of the invention, a wireless network for providing the child call log service comprises a network node and a child call log system. To provide the child call log service, the network node serves calls for a mobile device of a child. In addition to serving the calls for the child, the network node also records call information for the calls of the child, and transmits the call information to the child call log system. The child call log system stores the call information for the child in a call log for the child. At this point, the child call log system has a call log that includes recent call information for the child, such as call information for calls at least within the last week.

According to the child call log service, a parent of the child is able to access the call information for the child through the wireless network. To access the call information for the child, the parent transmits a request for the call information to the wireless network through a mobile device. The network node receives the request from the parent, and transmits a request for the call information to the child call log system. Responsive to the request from the network node, the child call log system accesses the call log for the child to identify the call information for the child. The child call log system then provides the call information for the child to the mobile device of the parent. The child call log system may provide the call information to the parent in many desired ways, such as in a text message, a multimedia message, an email message, a voice message, etc.

The invention may include other exemplary embodiments described below.

### DESCRIPTION OF THE DRAWINGS

The same reference number represents the same element on all drawings.

FIG. 1 illustrates an exemplary wireless network in an exemplary embodiment of the invention.

FIG. 2 is a flow chart illustrating an exemplary method of operating the wireless network of FIG. 1 to provide the child call log service in an exemplary embodiment of the invention.

FIG. 3 illustrates another exemplary wireless network in an exemplary embodiment of the invention.

FIG. 4 is a flow chart illustrating a method for registering mobile devices in the wireless network of FIG. 3 in an exemplary embodiment.

FIG. 5 is a flow chart illustrating a method of handling calls in the wireless network of FIG. 3 to provide the child call log service in an exemplary embodiment.

FIG. 6 is a flow chart illustrating a method of operating a child call log system to maintain a call log for a child in an exemplary embodiment.

FIG. 7 is a flow chart illustrating a method of accessing the call information for a child in an exemplary embodiment.

### DETAILED DESCRIPTION OF THE INVENTION

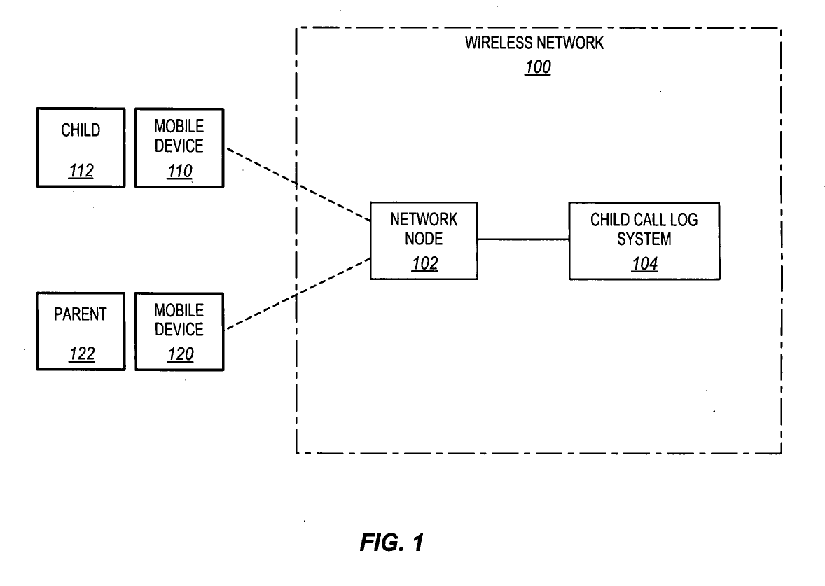

FIGS. 1-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an exemplary wireless network 100 in an exemplary embodiment of the invention. Wireless network 100 is adapted to provide a child call log service as will be described in more detail below. Wireless network 100 may comprise a Code Division Multiple Access (CDMA) network, a Time Division Multiple Access (TDMA) network, a Global System for Mobile Communication (GSM) network, or a Universal Mobile Telecommunications System (UMTS) network. Wireless network 100 includes a network node 102 and a child call log system 104 in this embodiment, but may include other networks, systems, or devices not shown in FIG. 1. For instance, wireless network 100 may include one or more base stations between network node 102 and mobile device 110 and 120, which is not shown for the sake of brevity.

Network node 102 includes any system, server, or other device that serves mobile devices for wireless communication, such as a Mobile Switching Center (MSC). In particular, network node 102 is adapted to serve a mobile device 110 of a child 112 and a mobile device 120 of a parent 122. Mobile devices 110 and 120 comprise any devices adapted to communicate via wireless signals, such as a cell phone, a PDA, or another type of mobile communication device. Those skilled in the art understand that mobile devices 110 and 120 may be served by different network nodes, but a single network node 102 is shown merely for illustrative purposes.

Network node 102 and child call log system 104 may each comprise instructions executable by a processing system to operate as described below to provide the child call log service. Some examples of instructions are software, program code, and firmware. The instructions are operational when executed by the processing system to direct the processing system to operate in accordance with the invention. The term “processing system” refers to a single processing device or a group of inter-operational processing devices. Some examples of processors are computers, integrated circuits, and logic circuitry.

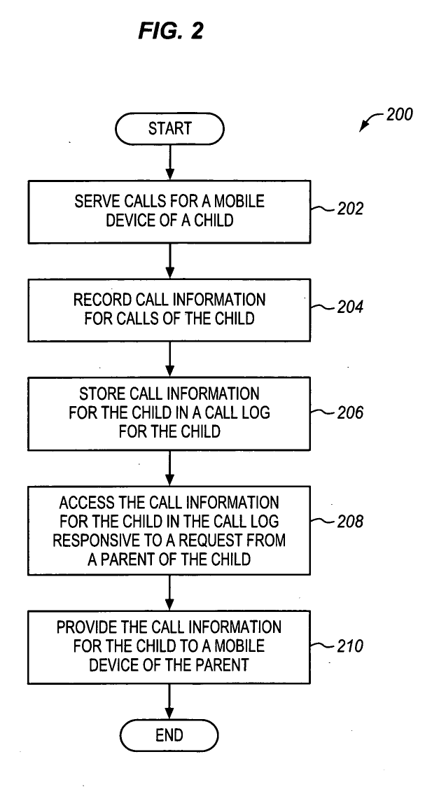

FIG. 2 is a flow chart illustrating an exemplary method 200 of operating wireless network 100 to provide the child call log service in an exemplary embodiment. The steps of method 200 will be described with reference to wireless network 100 in FIG. 1. The steps of the flow chart in FIG. 2 are not all inclusive and may include other steps not shown.

In step 202, network node 102 serves calls for mobile device 110 of child 112. To serve calls for mobile device 110, network node 102 may connect calls from mobile device 110 directed to other parties (not shown) through wireless network 100. Network node 102 may also connect calls from other parties to mobile device 110 through wireless network 100. As part of serving calls, network node 102 sets up, maintains, and tears down calls in wireless network 100.

In step 204, network node 102 records call information for the calls served for mobile device 110 of child 112. The call information may include directory numbers of the parties of the call, the duration of the call, the type of call, etc. Network node 102 then transmits the call information to child call log system 104. Network node 102 may transmit call information for a call to child call log system 104 responsive to the call being completed.

Child call log system 104 receives the call information for the calls for child 112, and stores the call information for child 112 in a call log for child 112 in step 206. If a call log does not already exist for child 112, then child call log system 104 creates a call log for child 112 and stores the call information for child 112 in the call log. If a call log already exists, then child call log system 104 stores the call information for child 112 in the call log. At this point, child call log system 104 has a call log that includes recent call information for child 112. Recent call information refers to call information for calls for child 112 within at least the last week. The call log may also include older call information. According to the child call log service, parent 122 is able to access the call information for child 112 through wireless network 100.

To access the call information for child 112, parent 122 transmits a request for the call information to wireless network 100 through mobile device 120 that is received by network node 102. Parent 122 may initiate the request for the call information by dialing a feature code (e.g., *61) in mobile device 120. Parent 122 may alternatively initiate the request for the call information by dialing a particular directory number assigned for the child call log service. The request from parent 122 may request particular call information, such as call information for calls for child 112 within at least the last week or for another specified time period (e.g., the last hour or the last day). The request from parent 122 may further request call information for the last call of child 112, call information on calls to a particular party, etc. Responsive to the request from parent 122, network node 102 transmits a request for the call information to child call log system 104. Network node 102 may authenticate parent 122 before transmitting the request for the call information to child call log system 104.

Responsive to the request from network node 102, child call log system 104 accesses the call log for child 112 to identify the call information for child 112 in step 208. In step 210, child call log system 104 provides the call information for child 112 to mobile device 120 of parent 122. Child call log system 104 may provide the call information to parent 122 in many desired ways. For instance, child call log system 104 may transmit the call information to parent 122 in the form of a text message or a multimedia message transmitted to mobile device 120. Child call log system 104 may transmit the call information to parent 122 in the form of an email message transmitted to mobile device 120. Child call log system 104 may transmit the call information to parent 122 in audible form, such as in a voice message or an announcement transmitted to mobile device 120.

Child call log system 104 is not intended to provide the call information to parent 122 in the form of a web page. Mobile device 120 of parent 122 may not be internet-enabled or may not have a web browser. Also, parent 122 may not have internet access through a home computer or a work computer. Thus, child call log system 104 is configured to provide the call information in another manner so that parent 122 may access the call information for child 112 through mobile device 120.

Wireless network 100 advantageously records call information for child 112 in a call log that can subsequently be accessed by parent 122 through mobile device 120. Because wireless network 100 continually updates the call log of child 112, parent 122 may advantageously access recent call information for the child, such as within the last hour, the last day, the last week, etc. Parent 122 does not need to wait to receive a monthly statement in order to view call information for child 112. Also, parent 122 may advantageously access call information for child 112 through mobile device 120 without requiring parent 122 to have internet and web-browsing capability through mobile device 120 or another system.

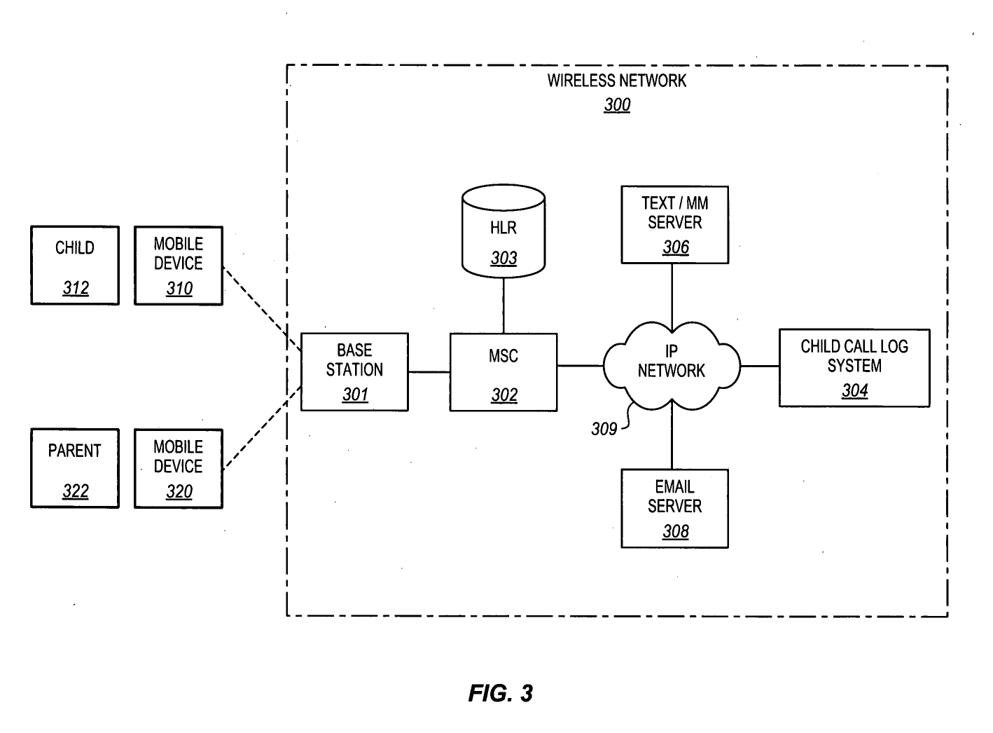

FIG. 3 illustrates another exemplary wireless network 300 in an exemplary embodiment of the invention. Wireless network 300 is adapted to provide the child call log service. Wireless network 300 includes a base station 301, an MSC 302, a Home Location Register (HLR) 303, a child call log system 304, a text/multimedia message server 306, and an email server 308 in this embodiment, but may include other networks, systems, or devices not shown in FIG. 3. MSC 302, child call log system 304, text/multimedia message server 306, and email server 308 are connected to one another over an IP network 309.

MSC 302 is adapted to serve a mobile device 310 of a child 312 and a mobile device 320 of a parent 322. Those skilled in the art understand that mobile devices 310 and 320 may be served by different MSCs, but a single MSC 302 is shown merely for illustrative purposes.

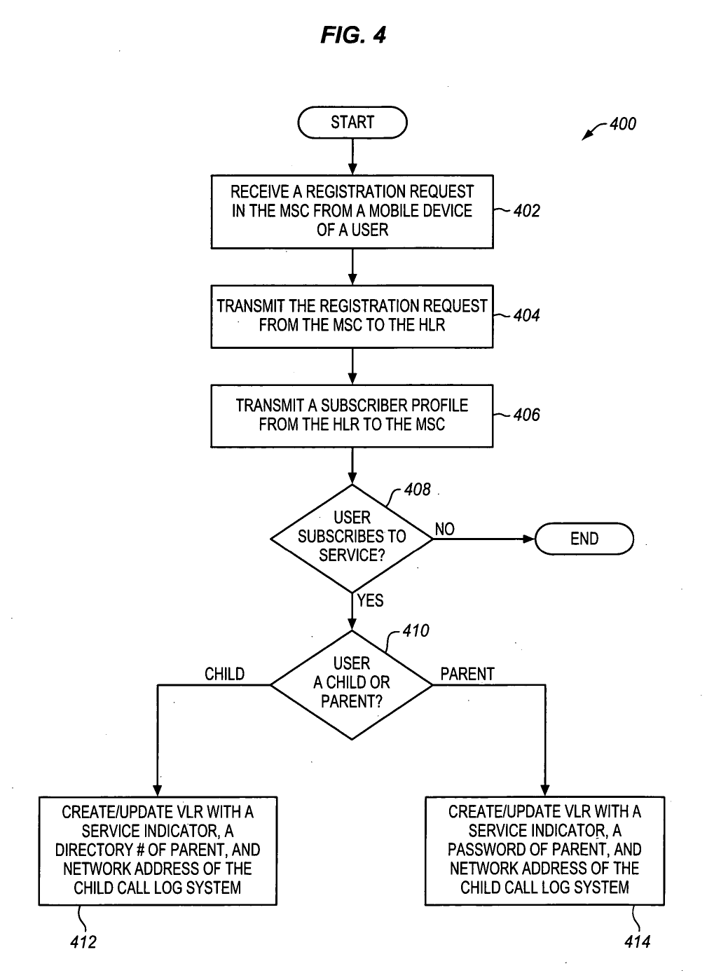

Parent 322 and child 312 have both subscribed to the child call log service through the service provider operating wireless network 300. To subscribe to the service, parent 322 establishes a user name and password that is subsequently used to authenticate parent 322 when parent 322 seeks to view the call information for child 312. The service provider also defines a network address for child call log system 304 that will be used to store the call log for child 312. Mobile devices 310 and 320 then register with wireless network 300 at some point, such as upon power up. FIGS. 4-7 illustrate methods of operating wireless network 300 to provide the child call log service.

FIG. 4 is a flow chart illustrating a method 400 for registering mobile devices in wireless network 300 in an exemplary embodiment. In step 402, MSC 302 receives a registration request from a mobile device of a user, such as mobile device 310 or 320 through base station 301. Responsive to the registration request from the mobile device, MSC 302 transmits a registration request to HLR 303 in step 404. Responsive to the registration request from MSC 302, HLR 303 transmits a subscriber profile for the user of the mobile device to MSC 302 in step 406. MSC 302 then processes the subscriber profile to determine if the user subscribes to the child call log service in step 408.

If the user does not subscribe to the child call log service, then method 400 ends. If the user subscribes to the child call log service, then MSC 302 determines whether the user is identified as child 312 or parent 322 in step 410. If the user is identified as child 312, then MSC 302 creates/updates the Visitor Location Register (VLR) for the user with a child call log service indicator, the directory number of parent 322, and a network address of child call log system 304 in step 412. If the user is identified as parent 322, then MSC 302 creates/updates the VLR for the user with a child call log service indicator, a password for parent 322, and a network address of child call log system 304 in step 414. Method 400 is performed for both mobile device 310 and mobile device 320 to register these devices.

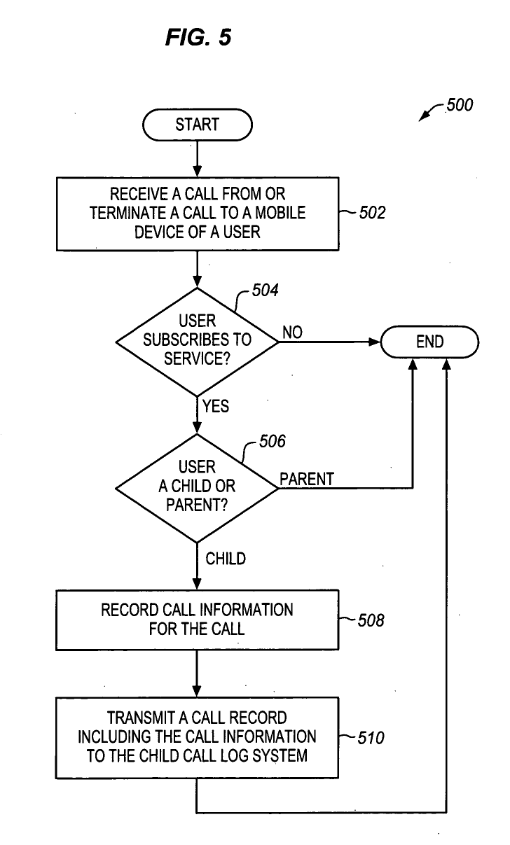

FIG. 5 is a flow chart illustrating a method 500 of handling calls in wireless network 300 to provide the child call log service in an exemplary embodiment. In step 502, MSC 302 receives a call from a mobile device or terminates a call to the mobile device, such as over base station 301. Responsive to the call, MSC 302 determines whether the user of the mobile device subscribes to the child call log service in step 504. MSC 302 makes this determination by accessing the VLR of the user to determine if the VLR includes a child call log service indicator. If the user of the mobile device does not subscribe to the child call log service, then method 500 ends. If the user of the mobile device does subscribe to the service, then MSC 302 determines whether the user is identified as child 312 or parent 322 in step 506. MSC 302 may determine whether the user is identified as child 312 or parent 322 based on the directory number of the user. If the user is identified as parent 322, then method 500 ends.

If the user is identified as child 312, then MSC 302 records call information for the call in step 508. The call information may include an identifier for child 312 (e.g., a directory number), an identifier for parent 322, an identifier of the other party to the call, a duration for the call, a call type, and possibly other information. When the call has been completed, MSC 302 generates a call record for the call based on the call information. One example of a call record is a Call Detail Record (CDR) traditionally generated by an MSC. MSC 302 then transmits the call record for the call to child call log system 304 in step 510 over IP network 309 for storage of the call record. MSC 302 may transmit the call record to child call log system 304 responsive to the call being completed so that child call log system. 304 has the most recent call information for call of child 312. Those skilled in the art understand that MSC 302 may also transmit a copy of the call record to a billing system (not shown).

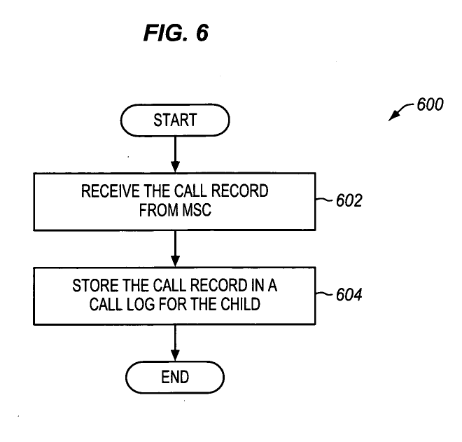

FIG. 6 is a flow chart illustrating a method 600 of operating child call log system 304 to maintain a call log for a child in an exemplary embodiment. In step 602, child call log system 304 receives the call record from MSC 302. Responsive to receiving the call record, child call log system 304 stores the call record in a call log for child 312 in step 604. If no call log exists, then child call log system 304 creates a call log for child 312 and stores the call record in the call log. If a call log already exists, then child call log system 304 stores the call record in the existing call log.

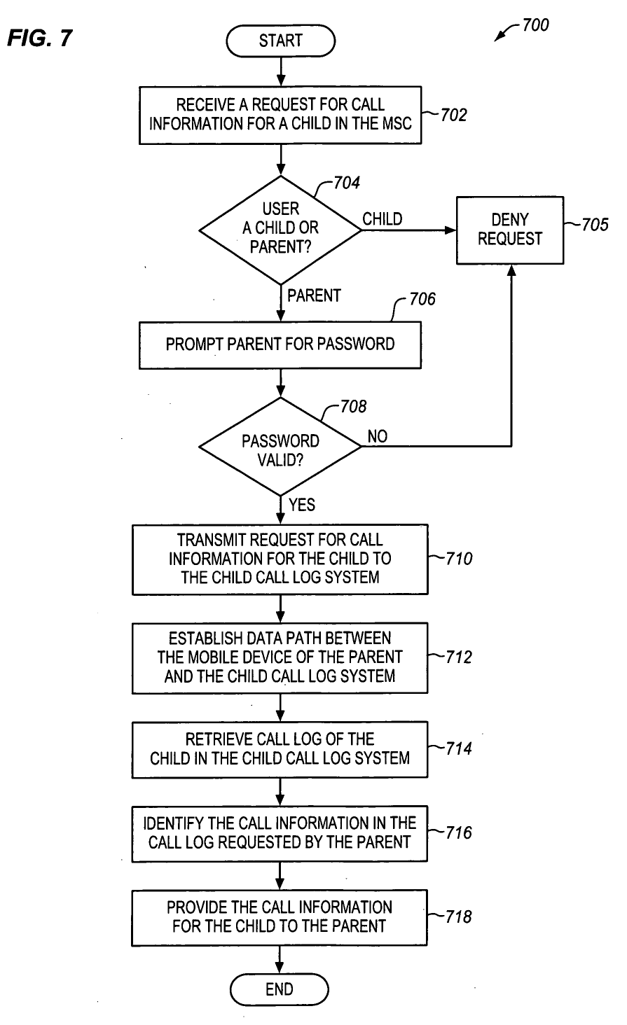

According to the child call log service, parent 322 is able to access call information for child 312 that is stored in the call log in child call log system 304. FIG. 7 is a flow chart illustrating a method 700 of accessing the call information for a child in an exemplary embodiment. In step 702, MSC 302 receives a request for call information for child 312 from a user of a mobile device, such as from parent 322 using mobile device 320. The request may include a directory number of the child for which call information is desired. The user may initiate the request for the call information by dialing a feature code (e.g., *61) in. the mobile device. The user may alternatively initiate the request for the call information by dialing a particular directory number assigned for the child call log service. The request from the user may request particular call information, such as call information for calls for child 312 within at least the last week or for another specified time period (e.g., the last hour or the last day). The request from the user may further request call information for the last call of child 312, call information on calls to a particular party, etc. In step 704, MSC 302 determines whether the requesting user is identified as parent 322. If the user is not identified as parent 322, then MSC 302 denies the request in step 705.

If the user is identified as parent 322, then MSC 302 prompts parent 322 for a password in step 706. MSC 302 receives a password from parent 322 through mobile device 320 and determines if the password is valid in step 708. If the password is not valid, then MSC 302 denies the request in step 705. If the password is valid, then parent 322 is authenticated as an authorized parent of child 312 that is allowed to access the call information for child 312.

In step 710, MSC 302 transmits a request for the call information for child 312 to child call log system 304 over IP network 309. MSC 302 is able to identify the network address for child call log system 304 in the VLR for parent 322. In step 712, MSC 302 then establishes a data path between mobile device 320 of parent 322 and child call log system 304.

Responsive to receiving the request for the call information from MSC 302, child call log system 304 retrieves the call log for child 312 in step 714. Child call log system 304 then identifies the call information in the call log that was requested by parent 322 in step 716. As previously stated, the request from parent 322 may request particular call information, such as call information for calls for child 312 within at least the last week or for another specified time period (e.g., the last hour or the last day). The request from parent 322 may further request call information for the last call of child 312, call information on calls to a particular party, etc. Child call log system 304 then provides the call information for child 312 to parent 322 in step 718.

Child call log system 304 may provide the call information to parent 322 in many desired ways. For instance, child call log system 304 may transmit the call information to text/multimedia message server 306 over IP network 309. Text/multimedia message server 306 then generates a text message (e.g., SMS message) or multimedia message (e.g., MMS message) that includes the call information for child 312, and transmits the message to mobile device 320 of parent 322 through MSC 302. Parent 322 may then view the call information provided in the text message through his/her mobile device 320.

Similarly, child call log system 304 may alternatively transmit the call information to email server 308 over IP network 309. Email server 308 then generates an email message that includes the call information for child 312, and transmits the email message to mobile device 320 of parent 322 through MSC 302. Parent 322 may then view the call information provided in the email message through his/her mobile device 320.

Child call log system 304 may alternatively transmit the call information to parent 322 in audible form. For instance, child call log system 304 may include text-to-speech hardware and/or software that convert the call information for child 312 to an audible format. Child call log system 304 may then provide the call information to parent 322 as a voice message or an announcement. Once again, child call log system 304 is not intended to provide the call information to parent 322 in the form of a web page.

The above embodiments of the child call log service describe the relationship of a parent and a child. In the above and other embodiments, the child call log service may also be extended to relationships other than the parent/child relationship. For instance, the child call log service (which may be generally referred to as a call log service) may be used for an employer/employee relationship or another relationship where one mobile user desires to access recent call information for another mobile user. The “child” in the above embodiments may be generally referred to as a target user. The “parent” in the above embodiments may be generally referred to as a requesting user that is requesting the call information for the target user. One assumption that is made is that the requesting user is authorized to access the call information for the target user due to the relationship between the requesting user and the target user, due to consent by the target user, etc. As an example, an employee (target user) may consent to the employer (requesting user) accessing call information for calls placed with a company mobile phone.

Although specific embodiments were described herein, the scope of the invention is not limited to those specific embodiments. The scope of the invention is defined by the following claims and any equivalents thereof.

We claim:

1. A wireless network for providing a child call log service, the wireless network comprising:
a network node adapted to serve calls for a mobile device of a child, and record call information for the calls of the child connected over the wireless network; and
a child call log system adapted to receive the call information for the child from the network node, and store the call information for the child in a call log for the child;
the network node being further adapted to receive a first request for call information for the child from a mobile device of a parent of the child, and transmit a second request for the call information for the child to the child call log system;
the child call log system being further adapted to access the call log for the child responsive to the second request to identify the call information for the child, and provide the call information for the child to the mobile device of the parent.

2. The wireless network of claim 1 wherein the first request for the call information for the child is for calls for the child within at least the last week.

3. The wireless network of claim 1 wherein the call information for the child includes at least a duration for a call and an indication of the other party to the call.

4. The wireless network of claim 1 wherein the first request for the call information comprises a feature code received from the mobile device of the parent.

5. The wireless network of claim 4 wherein the first request for the call information further comprises a directory number of the child.

6. The wireless network of claim 1 wherein the first request for the call information comprises a call received from the mobile device of the parent to a directory number assigned for the child call log service.

7. The wireless network of claim 1 wherein the child call log system is adapted to provide the call information for the child to the mobile device of the parent by transmitting one of a text message, a multimedia message, an email message, or a voice message to the mobile device of the parent that includes the call information for the child.

8. The wireless network of claim 1 wherein the network node is further adapted to:
authenticate the parent before transmitting the second request for the call information to the child call log system.

9. The wireless network of claim 8 wherein the network node is further adapted to:
prompt the parent for a password, receive a password from the parent through the mobile device, and determine if the password is valid to authenticate the parent before transmitting the second request to the child call log system.

10. A method of operating a wireless network for providing a child call log service, the method comprising:
generating a call log for a child based on call information for calls of the child connected over the wireless network;
receiving a request for the call information for the child from a mobile device of a parent of the child;
accessing the call log for the child to identify the call information for the child; and
providing the call information for the child to the mobile device of the parent responsive to the request.

11. The method of claim 10 wherein the request for the call information for the child is for calls for the child within at least the last week.

12. The method of claim 10 wherein the call information for the child includes at least a duration for a call and an indication of the other party to the call.

13. The method of claim 10 wherein receiving a request for the call information comprises:
receiving a feature code from the mobile device of the parent.

14. The method of claim 13 wherein receiving the request for the call information further comprises:
receiving a directory number of the child.

15. The method of claim 10 wherein receiving a request for the call information comprises:
receiving a call from the mobile device of the parent to a directory number assigned for the child call log service.

16. The method of claim 10 wherein providing the call information for the child to the mobile device of the parent comprises:
transmitting one of a text message, a multimedia message, an email message, or a voice message to the mobile device of the parent that includes the call information for the child.

17. The method of claim 10 further comprising:
authenticating the parent before providing the call information for the child to the mobile device of the parent.

18. The method of claim 17 wherein authenticating the parent comprises:
prompting the parent for a password;
receiving a password from the parent through the mobile device; and
determining if the password is valid to authenticate the parent before transmitting the second request to the child call log system.

19. A wireless network for providing a call log service, the wireless network comprising:
a network node adapted to serve calls for a mobile device of a target user, and record call information for the calls of the target user connected over the wireless network; and
a call log system adapted to receive the call information for the target user from the network node, and store the call information for the target user in a call log for the target user;
the network node being further adapted to receive a first request for call information for the target user from a mobile device of a requesting user, determine whether the requesting user is authorized to access call information for the target user, and transmit a second request for the call information for the target user to the call log system responsive to the requesting user being authorized;
the call log system being further adapted to access the call log for the target user responsive to the second request to identify the call information for the target user, and provide the call information for the target user to the mobile device of the requesting user.

20. The wireless network of claim 19 wherein the first request for the call information for the target user is for calls for the target user within at least the last week.
